(19) United States
(12) Patent Application Publication
(10) Pub. No.: US 2021/0122137 A1
(43) Pub. Date: Apr. 29, 2021

(54) A STRUCTURED KNITTED FABRIC AND METHOD OF PRODUCING IT

(71) Applicant: INTELLECTUAL SPORT GEAR S.R.L., Roma (RM) (IT)

(72) Inventor: Valeria MILITELLO, Anzio (Roma) (IT)

(21) Appl. No.: 16/757,199

(22) PCT Filed: Oct. 12, 2018
(86) PCT No.: PCT/IT2018/000129

§ 371 Date: Apr. 17, 2020

(30) Foreign Application Priority Data
Oct. 17, 2017 (IT) 102017000117330

(51) Int. Cl. B32B 3/12; B32B 5/02; B32B 5/08; B32B 27/40; D04B 1/10; B32B 37/28; B32B 37/04; B32B 7/09; D04B 1/12; D04B 1/24; B32B 27/12

(52) U.S. Cl. CPC B32B 3/12; D10B 2403/023; B32B 5/08; B32B 27/40; D04B 1/102; B32B 37/28; B32B 37/04; B32B 7/09; D04B 1/12; D04B 1/24; B32B 27/12; B32B 2250/40; B32B 2307/7265; B32B 2437/00; B32B 2262/0292; B32B 2307/728; B32B 2307/51; B32B 2250/03; B32B 2262/14; B32B 2307/304; B32B 2307/306; B32B 2307/724; D10B 2403/011; B32B 5/026

(57) ABSTRACT

Disclosed is a structured knitted fabric and method for production, having a single layer resulting from several components. The fabric has a knitted layer machined on circular machines, a membrane thermo-coupled to the internal surface of the knitted layer, and a fine knitted layer joined to the membrane or knitted layer and a waterproofing treatment on the external surface. Different combinations produce different fabrics. A first fabric includes a knitted layer, a membrane, and a waterproofing treatment and, depending on the weight of the knitted layer, is suitable for all sports, from skiing to cycling. A second fabric has a knitted layer, a fine knitted layer, and a waterproofing treatment, and is suitable for lightweight, breathable garments. Lastly, a third fabric has a knitted layer, a membrane, a fine knitted layer, and a waterproofing treatment, and is suitable for garments used in cold weather and for winter sports.

### TECHNICAL FIELD

The present invention relates to a structured knitted fabric and the production thereof which is particularly recommended for producing garments for dynamic activities.

### BACKGROUND ART

As it is known, nowadays, the need for clothing items with increasingly specialised and particular types of performance is leading researchers to develop increasingly higher performing fabrics aimed at meeting specific requirements.

Indeed, such fabrics, known as engineered fabrics, are materials which meet high technical and quality requirements and are used to produce garments with superior performance levels which meet the needs of the field of application thereof, including sportswear, but also for many other everyday items.

In particular, in the engineered fabric system, all kinds of textile fibres are used, such as, for example, natural, synthetic, artificial, inorganic fibres, with an increasing diffusion of the use of synthetic fibres, because it is possible to provide them with features suitable for the needs of different applications. In fact, technical fibres are designed and manufactured to provide performance levels not reachable with conventional textile fibres; they are mainly characterised by high levels of resistance to mechanical stress, flames, chemical agents, etc. These features can be achieved by modifying the process or other parameters that, apart from the fibres, contribute to the formation of the desired product. Fabrics made with the use of technical fibres can excel in terms of thermal exchange capacity, mechanical resistance, durability, and more.

Depending on the field of application, the technological features can be accompanied by comfort and style aspects. At present, engineered fabrics are finding increasing use in the clothing field, thus representing a meeting point between two worlds, namely fashion and engineering, which have ever larger areas of overlap. Engineered fabrics for both casual and sports clothing must combine comfort, resistance, breathability, ease of use, and maintenance with design.

At present, in terms of items of clothing, there is considerable need felt for garments which are increasingly ergonomic, allowing the user to perform a whole series of movements, including therein extreme movements, in total comfort and without any sense of constraint or limitation, allowing—at the same time—perfect breathability and thermoregulation so as not to strain the user's body during such activities.

In addition to the description so far, there is a demand expressed by the market for—for example—engineered fabrics which are capable, at the same time, of adapting to human ergonomics and offering optimum comfort and protection for the parts of the body with which the fabric comes into contact. In particular, the item of clothing or the accessory is required to feature the fewest number of seams possible since, with time and prolonged use, seams can irritate the body part concerned and the pressure exerted thereby can create irritations that limit the wearability of the item. Furthermore, people are seeking garments that offer a feeling of lightness and adaptability when worn, without any restrictions on and limitations to movements for the user.

As it is known, nowadays, there is a lot of interest among users in clothes and accessories which are comfortable, practical, functional, aesthetically pleasing, and flexible in terms of the use thereof, but most of all in those with high technological performance levels.

At present, many items of sportswear and other garments have inserts which are applied to the fabric which is the main structure of the garment to allow certain parts of the body good breathability, or to be more ergonomic during movement. Indeed, many garments feature portions made of a ribbed fabric, which is elastic and extensible. In all garments currently on the market, there are different layers of materials and fabrics that are positioned between the body and the outer layer so that the user often has a sense of padding and limitation in the movements thereof, which make it tiring to wear the garment for a long time.

Furthermore, in order to make the garments described above, various processes must be carried out to assemble the various parts and insert the various inserts and layers, before the finished garment is obtained. As a result of this condition, technical garments are particularly expensive due to the high number of steps which must be carried out for the production thereof. Moreover, the presence of different layers, each of which has its own task, means that the garment is not always comfortable in terms of wearability, since the garment is somewhat stiff and the wearer feels somewhat ‘trussed’.

### DISCLOSURE OF INVENTION

The aim of the present invention is essentially to solve the problems of the commonly known technique, overcoming the drawbacks described above by means of a structured knitted fabric which is produced with a layering of components, as one piece, without interruptions, with a raised structure on both the external and internal sides and with the modularity and elasticity of an actual seamless garment.

A second aim of the present invention is to provide a structured knitted fabric which adapts perfectly to the morphology of the part of the body with which it comes into contact, featuring differentiated thicknesses in the knit sequences achieved through differentiated interwoven sections in the machining.

A third aim of the present invention is to produce a structured knitted fabric using circular machines which offers the user optimal ergonomics, well sealed parts, excellent breathability, a decidedly contained weight, and considerable comfort when used.

A further aim of the present invention is to produce a structured knitted fabric whose construction features alternating areas with varying degrees of padding, which are lightweight or honeycombed so as to be breathable, and are elastic and flexible so as to be comfortable and ergonomic during movement.

A further aim of the present invention is to produce a structured knitted fabric which appears to be a single layer of material and a method of producing it.

A further but not final aim of the present invention is to provide a structured knitted fabric which is easy to produce and works well and a method of producing it.

These aims and others besides, which will better emerge over the course of the present description, are essentially achieved by means of a structured knitted fabric and method of producing it, as outlined in the claims below.

### BRIEF DESCRIPTION OF DRAWINGS

Further characteristics and advantages will better emerge in the detailed description of a structure knitted fabric and method of producing it according to the present invention, provided in the form of a non-limiting example, with reference to the accompanying drawings, in which:

FIG. 1 shows, schematically, a section of a first embodiment of a structured knitted fabric according to the present invention;

FIG. 2 shows, schematically, a section of a second embodiment of the fabric in question;

FIG. 3 shows, schematically, a section of a third embodiment of the structured knitted fabric in question;

FIG. 4 shows a top-down view of the knitted fabric in FIG. 1;

FIG. 5 shows a top-down view of the knitted fabric in FIG. 2;

FIG. 6 shows a top-down view of the structured knitted fabric in FIG. 3.

With reference to the figures, 1 denotes, as a whole, an embodiment of a structured knitted fabric according to the present invention.

### BEST MODE FOR CARRYING OUT THE INVENTION

The structured knitted fabric in question is essentially made according to the following method.

With a circular machine, a tubular element is formed on top of which the specific portions are “designed”, for example, to be breathable with a more open, honeycombed processing or with passages whose conformation allows the transit of air and/or ergonomic by means of ribbed portions that are particularly flexible and elasticised not so much as a result of the yarn, but as a result of the type of knitting.

Furthermore, through the type of knitting, it is possible to lend the fabric three-dimensionality, with raised elements on both the external and internal surfaces, so as to provide pre-established performance types for the future garment.

Once the tubular element has been obtained, it is turned inside out so that the external surface of the future fabric is on the inside.

During the subsequent stage, the upper part of the tubular element is sealed by means of a temporary seam, after inserting a polycarbonate sheet which covers the whole internal surface of the tubular element. The said sheet, which may have different dimensions, allows the entire surface of the tubular element to be tensioned while also stabilised, in order to render the surface perfectly homogeneous. This way, one obtains ‘pieces’ of knitted fabric corresponding to different sizes of the garments which will be produced.

At this point, a membrane is applied to the internal surface of the tubular element, which will subsequently become the internal surface of the garment and is currently located on the outside, and the said membrane may be composed of a single layer or multiple layers consisting of a membrane with a fine knitted layer, as shown in FIG. 3.

In greater detail, the membrane is constituted of a polyurethane film with hydrophilic characteristics and has a high capacity for heat resistance which facilitates the application thereof to the tubular element, in addition to increasing the strength and durability of the structured knitted fabric obtained.

In particular, the said membrane has an optimal capacity for two-dimensional extension and this characteristic is transmitted to the final fabric obtained.

In addition to the description so far, the said fine knitted layer is an extremely thin, elastic, and ductile fabric obtained with both natural and synthetic yarns and is designed to enable the thermoregulation of the garment since, depending on the thickness and weight thereof, the said layer lends the garment either a greater or lesser degree of protection from the cold. Indeed, for a winter garment, a fine knit can be used which is thicker and has a closer knit. Furthermore, to increase the characteristics consisting of protection from the cold, a nap may be made for the fine knitted layer, the said operation being part of the process of finishing the fabrics and consists in lifting the fibres of the yarns in the fabric, to render it softer and lighter, lending a napped, velvety appearance to the surface so as to increase the amount of air retained and, consequently, increase the thermal insulation property of the said fabric.

After positioning the membrane and/or the fine knitted layer, the tubular element is sealed (again, provisionally) in the lower portion too and a hot pressing operation is carried out by means of a special press which, by providing adequate heat, reciprocally couples the materials, keeping the three-dimensionality of the surfaces unchanged.

The operation of positioning the membrane plus the fine knitted layer is repeated in the other half of the tubular element, which has been rotated. Once the stage during which the membrane is applied to the whole surface of the tubular element is finished, the lower portion is opened and the polycarbonate sheet is removed, which, as mentioned earlier, was keeping the knit of the tubular element slightly tensioned and also had the further task of preventing the two halves from mutually joining, so as to tension the knitted fabric and give the latter a pre-established size and measurements.

The following stage envisages the removal of the provisional upper stitching and the opening of the tubular element, which becomes a rectangular portion.

A waterproofing treatment is performed on the external surface or on the side opposite where the membrane has been applied in order to render the external surface waterproof.

There follows a drying stage which entails a passage through a suitable device which warms and thereby dries.

At this point, the piece of structured knitted fabric obtained is ready to be used to create all the structures necessary for the production of garments for dynamic activities.

The structured knitted fabric obtained with the method disclosed above, consists of a single piece which is the result of the assembly of several components. In particular, depending on the fibres and the materials used for the production of the knitted fabric, clearly defined characteristics can be given to the end fabric, with the thicknesses or the honeycomb designed according to the effect one wishes to achieve in order to calibrate and manage body microclimate and thermoregulation. Furthermore, one can predetermine the level of elasticity and flexibility of the fabric so that the said fabric is comfortable and dynamic during movement.

With the method disclosed above, one can obtain portions of bellow-shaped fabric which allow optimal elbow and/or knee movement without any overlapping fabric, which—over time—would cause discomfort and irritation due to the folds rubbing against the body.

Furthermore, portions can be obtained with ribbing with different inter-row thicknesses, which allow an air tightness that performs an insulation function or lends the fabric breathability in order to wick away sweat or control the internal temperature of the garment, so as to provide the user with an optimum microclimate.

In addition to the description so far, since the fabric is knitted, once can produce, for example, smooth portions to be sewn in a normal manner, for example, to apply a zip, which is impossible with currently available products. Furthermore, one can create designs and textures which render the fabric special aesthetically and lend it value.

In particular, with the knitting according to the present method, on the reverse side of the fabric, there are no floating yarns, loose ends, or anything else which would render the fabric aesthetically untidy, which is why it is often the case, in currently available garments, that there is always a lining present to hide such imperfections.

A structured knitted fabric in question combines the typical features of a seamless garment—i.e. the level of comfort during movements, since there are no seams holding taut and stiffening the fabric and therefore the said fabric is soft and extensible)—with the performance of the membrane, i.e. breathability, external humidity being kept external, and internal humidity being wicked away.

According to the present invention, the structured knitted fabric in question is essentially constituted of a knitted layer 2, produced using circular machines, at least one membrane 3 which is thermo-coupled to the internal surface of the knitted layer and a fine knitted layer joined to the membrane or the knitted layer and a waterproofing treatment on the external surface.

In addition to the description so far, the structured knitted fabric is the result of different combinations of the three components: knitted layer 2, membrane 3, and fine knitted layer 4.

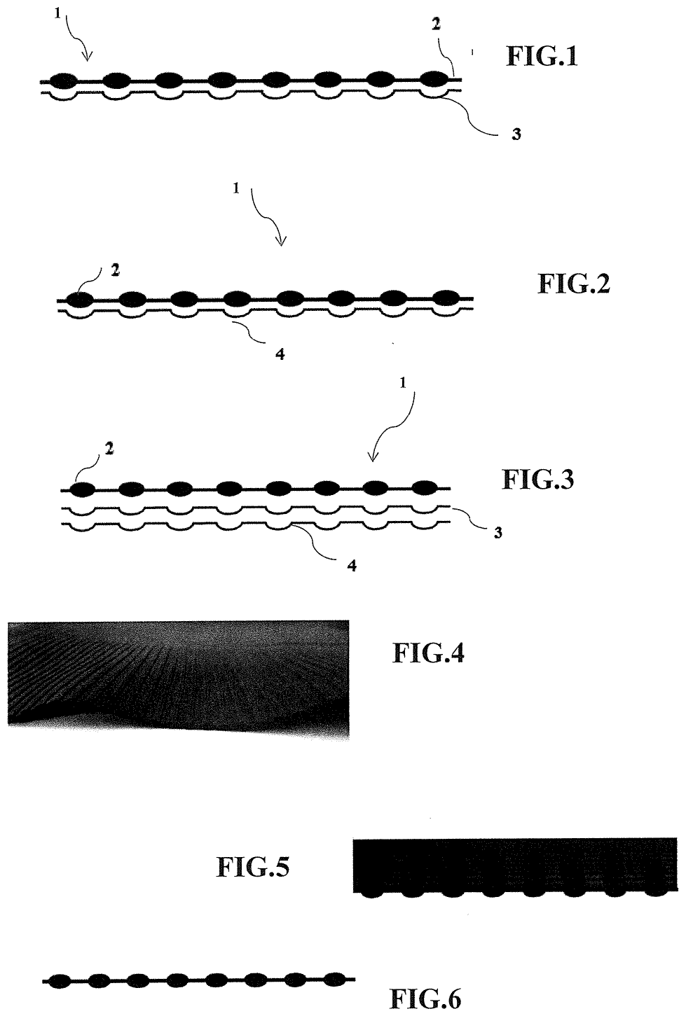

In greater detail, a first fabric composed of a knitted layer 2 and a membrane 3 with the waterproofing on the external surface, shown in FIG. 1, depending on the weight of the knitted layer, is suitable for all sports from skiing to cycling. A second fabric composed of a knitted layer 2 and a fine knitted layer 4 and with the waterproofing on the external surface, shown in FIG. 2, is suitable for lightweight and breathable garments in which the knit layer is joined with the fine knitted layer by means of polyurethane stitches distributed over the surface which join the two layers. A third fabric composed of a knitted layer 2, a membrane 3, and a fine kitted layer 4, with the waterproofing on the external surface, shown in FIG. 3, is suitable for garments used in cold weather, in particular for winter sports, such as skiing, for example. As mentioned earlier, the knitted layer 2 features different thicknesses due to the use of yarns which differ in terms of both type and thickness, as well as the type of machining carried out with a given sector.

Indeed, the knitted layer 2 may be made of various types of yarns, which may be natural or synthetic or an association of the two types or originating from the intertwining of yarns of different types and thicknesses.

In accordance with the present invention, the structured knitted fabric may have different thicknesses which allow for a more specific and sectoral design of the piece, thereby also allowing the product to be given specific technical features at points of need.

Indeed, for example, the thickness of the knit allows the fabric to have controlled flexibility and the thicker the knit is, the more insulated and cushioned the fabric is, thereby guaranteeing greater support and, consequently, a higher level of comfort. Furthermore, the zones with more padding provide greater protection and there is less possibility of dispersion of internal heat.

In addition to the description so far, the thinner the knit is, the more the fabric offers optimum climate control for the part of the body with which it comes into contact and effective breathability, as the way in which the section of fabric is produced means it is endowed with open passages that allow better and greater air circulation and therefore better climate control with the temperature kept even and constant.

With the structured knitted fabric in question there can be differentiated comfort zones.

In addition to the description so far, when—for example—the knitted layer features machining which creates a full knit, it prevents the inlet of humidity and water, while the presence of honeycombing and openings for the passage of air does not allow the inlet of dust, etc. which means nothing can enter the garment which might cause discomfort to the user's body; indeed, only air can enter.

The knitted layer is contoured since produced with knits which allow (anatomical) pre-shaping by means of different selections, yarns, gauges, etc.

Different types of machining ensure the knitted layer obtained has structural features that are transformed into functional features for the garment.

In particular, the structured knitted fabric may be used to make garments such as jackets and trousers, waistcoats, jumpers, and gloves, for both sports and not, and may be used in the production of technical garments for both sports and casual wear or even solely parts thereof, where particular characteristics and types of performance are required.

All the inserts and the different types of structure of the knitted layer are obtained during machining, which means there are no seams that can cause discomfort, irritations, or stress to the zone of the body which comes into contact therewith.

Last but not least, the structured knitted fabric in question is the end result of precise working stages, which means the resulting fabric is the epitome of high-performance technique, which can be applied to fashion, sports, etc.

After the predominantly structural description, the invention in question will now be outlined.

When one wishes to produce an item of clothing or a part thereof, one simply has to produce the knitted layer and complete it with the membrane and/or fine knitted layer and the waterproofing treatment according to the present invention and use the fabric obtained to produce the desired item of clothing by assembling the fabric with the other components, in the same way as a normal piece of fabric. The difference will lie in the performance and the characteristics that the fabric can offer, such as optimum comfort, which is diversified depending on the points in the body, and climate control, which can be different from one zone to another zone.

Thus the present invention achieves the aims set.

With the structured knitted fabric in question, it is possible to make inserts, for example, in jackets and trousers, or an entire garment.

Advantageously, the fabric obtained with the method in question is constituted of a layering of components resulting in a single layer which makes the fabric a single piece, without interruptions, with a raised structure on both the external and internal sides and with the modularity and elasticity of an actual seamless garment, improving breathability and ergonomics during movement when wearing the garment and is not simply a sum of layers and elements, as happens with garments according to prior art.

In particular, the structured knitted fabric in question is configured so as to adapt perfectly to the morphology of the part of the body with which it comes into contact, features differentiated thicknesses in the sequences of the different rows of knitting and features differentiated interwoven sections in the machining, which allow diversified portions of fabric to be obtained in order to achieve optimum breathability with differentiated zones for aeration and air circulation as needed.

A further advantage of the knitted fabric in question is that it is produced using a circular machines, without the need for subsequent machining (except the subsequent assembly thereof with the membrane and the waterproofing of the external surface) to give the user a garment which has optimum wearability, air tightness, excellent breathability, decidedly contained weight, support, and remarkable comfort when worn. Furthermore, the construction of the fabric according to the present invention involves alternating areas with varying degrees of thickness, which are lightweight and honeycombed so as to be breathable and provide heat regulation.

A further advantage of the fabric in question is that once production thereof is finished, the fabric is as if it consisted of a single layer/element.

In particular, because of its structure, the fabric according to the present invention adapts perfectly to the morphology of the part of the body, without any uncomfortable areas of thickness or folds.

Advantageously, an item of clothing made with the fabric according to the present invention can have an unusual, refined, and aesthetically attractive appearance, while also offering a high level of technical performance.

One advantage achieved with the use of the present fabric is that the elements of disturbance and discomfort are reduced/eliminated, making the user more comfortable during the movement thereof.

A further advantage is due to the fact that the structured knitted fabric in question is easy to manufacture and works well.

Naturally, further modifications or variants may be applied to the present invention while remaining within the scope of the invention that characterises it.

1. A structured knitted fabric composed of a single layer which is the result of the assembly of several components wherein the said fabric is essentially constituted of a knitted layer (2) machined on circular machines, a membrane (3) thermo-coupled to the internal surface of the knitted layer, and a fine knitted layer (4) joined to the membrane or knitted layer and a waterproofing treatment on the external surface, where the said structured knitted fabric is the result of different combinations of the three components, namely: knitted layer (2), membrane (3) and fine knitted layer (4), wherein:
a first fabric consists of a knitted layer (2), a membrane (3) and a waterproofing treatment and, depending on the weight of the knitted layer, is suitable for all sports from skiing to cycling,
a second fabric is composed of a knitted layer (2), a fine knitted layer (4) and a waterproofing treatment, and is suitable for lightweight and breathable garments,
a third fabric consists of a knitted layer (2), a membrane (3), a fine knitted layer (4) and a waterproofing treatment and is suitable for garments used for cold weather and winter sports.

2. A structured knitted fabric according to claim 1, wherein, in the second fabric, the joining of the two components is achieved by means of polyurethane stitches arranged over the surface which allow the joining of the two layers.

3. A structured knitted fabric according to claim 1, wherein the knitted layer (2) features different thicknesses due to the use of different yarns, as well as the type of machining in a predetermined sector being carried out with various types of yarns, which may be natural or synthetic or a combination of the two, or may be derived from the intertwining of yarns of different types and thicknesses.

4. A knitted fabric according to claim 1, wherein the membrane (3) is constituted of a polyurethane film with hydrophilic characteristics and has a high capacity for heat resistance which facilitates the application thereof to the tubular element, in addition to increasing the strength and durability of the structured knitted fabric obtained, the said membrane having an optimal capacity for two-dimensional extension, a characteristic which is transmitted to the final fabric obtained.

5. A structured knitted fabric according to claim 1, wherein the said fine knitted layer (4) is an extremely thin, elastic and ductile fabric obtained with both natural and synthetic yarns and is designed to enable the thermoregulation of the garment since, depending on the thickness and weight thereof, the said layer lends the garment either a greater or lesser degree of protection from the cold, and for a winter garment a fine knit can be used which is thicker and has a closer knit.

6. A structured knitted fabric according to claim 1, wherein the said fine knitted layer (4) features teaselling which raises the fibres of the weave yarns, making the layer soft and fluffy and lending the surface a nap and a velvety appearance so as to increase the amount of air retained and increase the thermal insulation properties of the knitted fabric obtained.

7. A structured knitted fabric according to claim 1, wherein, depending on the fibres and the materials used for the production thereof, the said knitted layer (2) lends the final fabric clearly defined characteristics, wherein the pre-defined thicknesses or honeycomb effect calibrate and manage body microclimate and thermoregulation and predetermine the elasticity and flexibility of the fabric so that the said fabric is comfortable and dynamic during movement.

8. A structured knitted fabric according to claim 1, wherein in addition to the “seamless” features, which provide a level of comfort during movements since there are no seams holding the fabric taut (therefore the said fabric is soft and extensible), the membrane features include breathability, external humidity being kept external, and internal humidity being wicked away.

9. A method of producing a structured knitted fabric according to claim 1, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside, sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

10. The method according to claim 9, wherein said sheet allows the entire surface of the tubular element to be tensioned while also stabilised, in order to render the surface perfectly homogeneous, and features different dimensions to obtain knitted fabrics with different sizes corresponding to different sizes of the garments which will be produced.

11. A procedure according to claim 9, wherein the said procedure may obtain:
portions of bellow-shaped fabric which allows optimal elbow and/or knee movement without any overlapping fabric,
portions with different inter-row thicknesses which allow an air tightness that performs an insulation function or lends the fabric breathability in order to wick away sweat or control the internal temperature of the garment, so as to provide the user with an optimum microclimate,
smooth portions than can be sewn in a normal manner and for application of a zip,
portions with designs and weaves which make the fabric aesthetically special and valuable without the presence of floating yarns, lose ends, or other elements on the rear of the fabric.

12. A method of producing a structured knitted fabric according to claim 2, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

13. A method of producing a structured knitted fabric according to claim 3, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

14. A method of producing a structured knitted fabric according to claim 4, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

15. A method of producing a structured knitted fabric according to claim 5, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

16. A method of producing a structured knitted fabric according to claim 6, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

17. A method of producing a structured knitted fabric according to claim 7, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.

18. A method of producing a structured knitted fabric according to claim 8, wherein the said method essentially comprises the following operational steps:
production, using a circular machine, of a tubular element on which—by means of knitting—a three-dimensionality of the knitted layer is achieved, with elements in relief on both the external and internal surfaces, to provide a predetermined performance for the future garment, and where breathable portions are “designed” and defined by means of more open, honeycomb machining or with through-holes which allow the passage of air due to the conformation thereof and/or are ergonomic with ribbed sections which are particularly flexible and elasticised not so much because of the yarn used, but due to the type of knitting,
turning the tubular element obtained inside out so that the external surface of the future fabric is on the inside,
sealing the upper part of the tubular element by means of a temporary seam, after inserting a polycarbonate sheet which covers the whole internal surface of the tubular element,
application of the tubular element to the internal surface, which will subsequently become the internal surface of the garment and is located externally to a membrane composed of single layer or multiple layers consisting of a membrane with a fine knitted layer,
sealing by means of a temporary seam, after positioning the membrane and/or fined knitted layer of the tubular element in the lower portion,
hot pressing by means of a suitable press which, by supplying adequate heat, allows the reciprocal coupling of the materials, maintaining the original three-dimensionality of the surfaces,
positioning of the membrane and/or fine knitted layer in the other half of the tubular element which has been rotated,
removal of the temporary seam from the lower portion of the tubular element and removal of the polycarbonate sheet which was keeping the knitted layer slightly taut, tensioning the said knitted layer to a predetermined size or measurement, and was preventing the two halves of the tubular element joining during the pressing,
removal of the upper temporary seam and opening of the tubular element, thus making the said element a rectangular portion,
performance of a waterproofing treatment on the external surface or on the side opposite where the membrane and/or fine knitted layer has been applied in order to render the external surface water-resistant,
drying, by means of a passage through a suitable device which
by warming the piece of knitted fabric obtained—dries the said piece, which is then ready to be used to create all the structures necessary for the production of garments for dynamic activities.
